(19) United States
(12) Patent Application Publication
(10) Pub. No.: US 2020/0193888 A1
(43) Pub. Date: Jun. 18, 2020

(54) POWER SAVING METHOD APPLIED TO SOURCE DRIVER OF DISPLAY

(71) Applicant: Raydium Semiconductor Corporation, Hsinchu (TW)

(72) Inventors: Pine TSAI, New Taipei City (TW); YM CHANG, Taipei City (TW); Hank LIN, New Taipei City (TW)

(21) Appl. No.: 16/710,196

(22) Filed: Dec. 11, 2019

Related U.S. Application Data
(60) Provisional application No. 62/778,327, filed on Dec. 12, 2018.

(51) Int. Cl. G09G 3/20

(52) U.S. Cl. CPC G09G 3/20; G09G 2320/0242; G09G 2330/021

(57) ABSTRACT

A power saving method applied to source drivers of a display is disclosed. The method includes steps of: grouping the output channels of each source driver respectively; setting a charge-sharing average register; selecting whether the data signal is reverse processed; calculating an average of the data lines after charge-sharing; calculating the total power consumption of the data signal from the (N−1)-th data line to the N-th data line under all charge-sharing modes, wherein N is a positive integer greater than 1; selecting a candidate lowest power consumption charge-sharing mode corresponding to each source driver; voting the lowest power charge-sharing mode from those candidate lowest power consumption charge-sharing modes; and controlling the operation of each source driver according to the lowest power charge-sharing mode.

### BACKGROUND OF THE INVENTION

### 1. Field of the Invention

The invention relates to a display; in particular, to a power saving method applied to a source driver of a display.

### 2. Description of the Prior Art

For the source driver of the display, there is a charge sharing algorithm between any channels, which is applicable to all panel pixel structures, and can ensure that the best way for charge-sharing between any two lines can be selected.

However, if the two display areas on the display panel have the same background color, the calculation results obtained after performing the above-mentioned charge-sharing algorithm may be different; for example, the calculation results of the two display areas can be to perform charge-sharing or perform no charge-sharing respectively. As a result, the color difference, which should not exist, is found between two display areas which should originally display the same hue, so that the hue of the overall display panel becomes inconsistent. This issue needs to be further resolved.

### SUMMARY OF THE INVENTION

Therefore, the invention provides a power saving method applied to a source driver of a display to solve the above-mentioned problems occurred in the prior arts.

An embodiment of the invention is a power saving method. In this embodiment, the power saving method is applied to a plurality of source drivers of a display. A first source driver, a second source driver, . . . . and a K-th source driver of the plurality of source drivers correspond to a first display area, a second display area, . . . and a K-th display area of a display panel respectively. The first source driver includes a plurality of first output channels, the second source driver includes a plurality of second output channels, . . . , and the K-th source driver includes a plurality of K-th output channels. K is a positive integer larger than 1. The power saving method includes steps of:

(a) dividing the plurality of first output channels of the first source driver into a plurality of sets of first output channels and each set of first output channels includes M first output channels, wherein M is a positive integer;

(b) setting a charge-sharing average register;

(c) selecting whether the data signal is reverse processed;

(d) calculating an average of the (N−1)-th data line after charge-sharing, wherein N is a positive integer larger than 1;

(e) determining whether the data signal outputted by each output channel consumes power from the (N−1)-th data line to the N-th data line respectively;

(f) calculating a total power consumption of the data signal transmitted from the (N−1)-th data line to the N-th data line under all charge-sharing modes;

(g) selecting a first candidate lowest power consumption charge-sharing mode corresponding to the first source driver from all charge-sharing modes;

(h) repeatedly performing the step (a) to the step (g) on the second source driver to the K-th source driver respectively to select a second candidate lowest power consumption charge-sharing mode corresponding to the second source driver to a K-th candidate lowest power consumption charge-sharing mode corresponding to the K-th source driver respectively;

(i) voting a lowest power consumption charge-sharing mode from the first candidate lowest power consumption charge-sharing mode to the K-th candidate lowest power consumption charge-sharing mode; and

(j) controlling operations of the plurality of source drivers according to the lowest power consumption charge-sharing mode.

In an embodiment, if each first output channel has J charge-sharing paths, then the M first output channels totally correspond to (J+1)^{M} charge-sharing average registers, wherein J is a positive integer.

In an embodiment, the step (e) is to determine whether the power is consumed according to a voltage-level change of the data signal outputted by each first output channel when the data signal is transmitted from the (N−1)-th display line to the N-th display line.

In an embodiment, if the voltage-level change is far away from a reference voltage-level, then the step (e) determines that the power is consumed.

In an embodiment, the reference voltage-level is a ground voltage.

In an embodiment, if the voltage-level change is approaching a reference voltage-level, then the step (e) determines that no power is consumed.

In an embodiment, the reference voltage-level is a ground voltage.

In an embodiment, if the step (c) selects a normally white mode, the data signal is reverse processed; if the step (c) selects a normally black mode, the data signal is not reverse processed.

In an embodiment, the step (j) achieving the lowest power consumption charge-sharing mode for the K source drivers by switching the coupling relationship between the plurality of first output channels, switching the coupling relationship between the plurality of second output channels, . . . and switching the coupling relationship between the plurality of K-th output channels respectively.

In an embodiment, the first candidate lowest power consumption charge-sharing mode to the K-th candidate lowest power consumption charge-sharing mode are the same or different from each other, and the step (i) is to select one of the first candidate lowest power consumption charge-sharing mode to the K-th candidate lowest power consumption charge-sharing mode having the highest number of votes as the lowest power charge sharing mode.

Compared with the source drivers corresponding to different display areas selecting their own lowest power consumption charge-sharing modes respectively in the prior art, thereby causing color difference which should not exist between the two display regions whose original colors should be the same, the present invention proposes a power saving method for all source drivers corresponding to all display areas of the display panel to vote the lowest power consumption charge-sharing mode from all candidate lowest power consumption charge-sharing modes and then the lowest power consumption charge-sharing mode is applied to all display areas of the display panel, so that the above-mentioned color difference can be avoided and the hue of the overall display panel will become uniform.

The advantage and spirit of the invention may be understood by the following detailed descriptions together with the appended drawings.

### BRIEF DESCRIPTION OF THE APPENDED DRAWINGS

FIG. 1 illustrates a flowchart of the power saving method applied to the source driver of the display in a preferred embodiment of the invention.

FIG. 2 illustrates a schematic diagram of the first source driver SD1 to the fourth source driver SD4 coupling to the first display area R1 to the fourth display area R4 of the display panel PL through the first output channel CH1 to the fourth output channel CH4 respectively.

### DETAILED DESCRIPTION OF THE INVENTION

Reference will now be made in detail to the exemplary embodiments, the same or similar reference numbers or components used in the drawings and the embodiments are used to represent the same or similar parts.

An embodiment of the invention is power saving method applied to a source driver of a display. In this embodiment, the display can be various types of display screen products such as computer screens, televisions, monitors, but not limited to this.

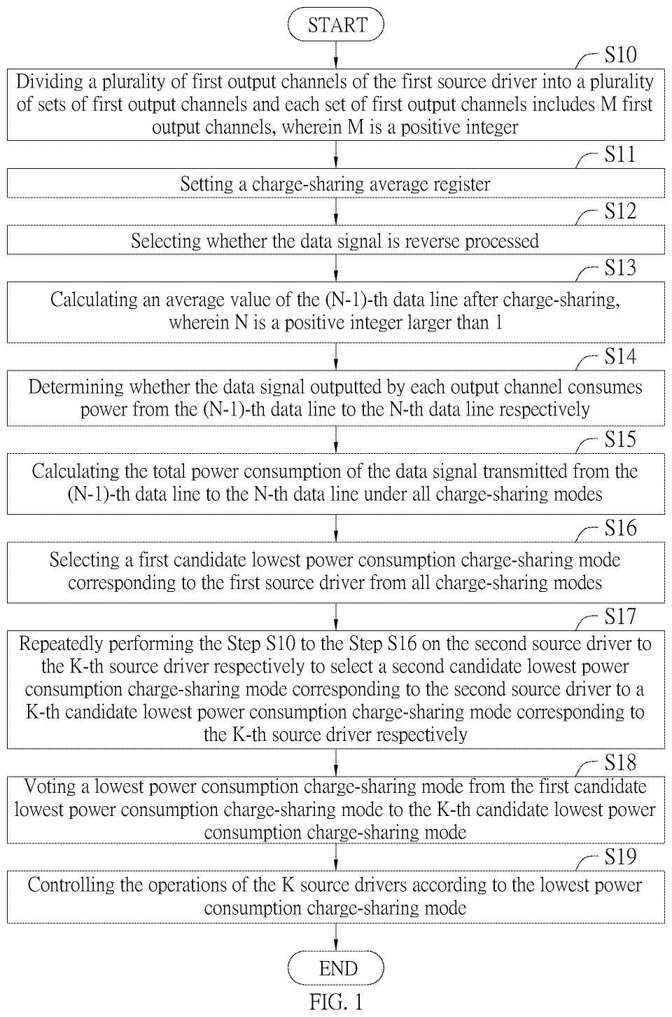

Please refer to FIG. 1. FIG. 1 illustrates a flowchart of the power saving method applied to the source driver of the display in this embodiment. It is assumed that the entire display area of the display panel of the display is divided into K display areas, that is, a first display area, a second display area, . . . and a K-th display area, where K is a positive integer larger than 1. And, the K display areas correspond to K source drivers respectively, that is, the first display region corresponds to the first source driver, the second display region corresponds to the second source driver, . . . and the K-th display region corresponds to the K-th source driver. The first source driver includes a plurality of first output channels coupled to the first display area, . . . and the K-th source driver includes a plurality of K-th output channels coupled to the K-th display area.

As shown in FIG. 1, the power saving method can include the following steps of:

Step S10: dividing a plurality of first output channels of the first source driver into a plurality of sets of first output channels and each set of first output channels includes M first output channels, wherein M is a positive integer;

Step S11: setting a charge-sharing average register;

Step S12: selecting whether the data signal is reverse processed;

Step S13: calculating an average value of the (N−1)-th data line after charge-sharing, wherein N is a positive integer larger than 1;

Step S14: determining whether the data signal outputted by each output channel consumes power from the (N−1)-th data line to the N-th data line respectively;

Step S15: calculating the total power consumption of the data signal transmitted from the (N−1)-th data line to the N-th data line under all charge-sharing modes;

Step S16: selecting a first candidate lowest power consumption charge-sharing mode corresponding to the first source driver from all charge-sharing modes;

Step S17: repeatedly performing the Step S10 to the Step S16 on the second source driver to the K-th source driver respectively to select a second candidate lowest power consumption charge-sharing mode corresponding to the second source driver to a K-th candidate lowest power consumption charge-sharing mode corresponding to the K-th source driver respectively;

Step S18: voting a lowest power consumption charge-sharing mode from the first candidate lowest power consumption charge-sharing mode to the K-th candidate lowest power consumption charge-sharing mode; and

Step S19: controlling the operations of the K source drivers according to the lowest power consumption charge-sharing mode.

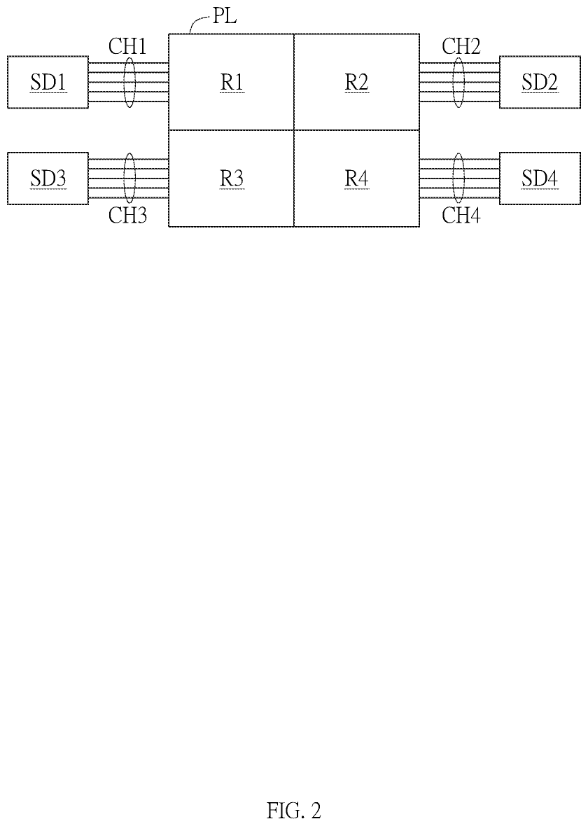

For example, as shown in FIG. 2, it is assumed that the entire display area of the display panel PL can be divided into a first display area R1 to a fourth display area R4, and a first source driver SD1 to a fourth source driver SD4 correspondingly coupling to the first display area R1 to the fourth display area R4 through the first output channels CH1 to the fourth output channels CH4 respectively. It should be noted that, in the embodiment of FIG. 2, four display areas and four corresponding source drivers are taken as an example, but the actual display area and the corresponding number of source drivers are not limited to this.

In practical applications, if each first output channel CH1 of the first source driver SD1 has J charge-sharing paths, then the M first output channels CH1 of the first source driver SD1 correspond to (J+1)^{M} charge-sharing average registers, wherein J is a positive integer. Similarly, the second source driver SD2 to the fourth source driver SD4 can also be deduced by analogy, and will not be further described herein.

In an embodiment, the Step S14 is to determine whether the power is consumed according to a voltage-level change of the data signal outputted by each first output channel CH1 of the first source driver SD1 when the data signal is transmitted from the (N−1)-th display line to the N-th display line. If the voltage-level change is far away from a reference voltage-level, then the Step S14 determines that the power is consumed. If the voltage-level change is approaching the reference voltage-level, then the Step S14 determines that no power is consumed. In fact, the reference voltage-level can be a ground voltage, but not limited to this. Similarly, the second source driver SD2 to the fourth source driver SD4 can also be deduced by analogy, and will not be further described herein.

In an embodiment, the Step S12 selecting whether the data signal is reverse processed can include the following steps: if the normally white mode is selected in the Step S12, the data signal is reverse processed; if the normally black mode is selected in the Step S12, the data signal is not reverse processed.

In an embodiment, the Step S19 can achieve the lowest power consumption charge-sharing mode for the first source driver SD1 to the fourth source driver SD4 by switching the coupling relationship between the plurality of first output channels CH1 of the first source driver SD1, switching the coupling relationship between the plurality of second output channels CH2 of the second source driver SD2, . . . and switching the coupling relationship between the plurality of fourth output channels CH4 of the fourth source driver SD4 respectively.

In an embodiment, the first candidate lowest power consumption charge-sharing mode corresponding to the first source driver SD1 to the fourth candidate lowest power consumption charge-sharing mode corresponding to the fourth source driver SD4 can be the same or different to each other. The Step S18 can select one of the first candidate lowest power consumption charge-sharing mode to the fourth candidate lowest power consumption charge-sharing mode having the highest number of votes as the lowest power charge sharing mode to apply the lowest power charge sharing mode to all source drivers (i.e., the first source driver SD1 to the fourth source driver SD4), so that the color difference between the two display areas having the same background color can be avoided, and the hue of the overall display panel will become uniform.

Compared with the source drivers corresponding to different display areas selecting their own lowest power consumption charge-sharing modes respectively in the prior art, thereby causing color difference which should not exist between the two display regions whose original colors should be the same, the present invention proposes a power saving method for all source drivers corresponding to all display areas of the display panel to vote the lowest power consumption charge-sharing mode from all candidate lowest power consumption charge-sharing modes and then the lowest power consumption charge-sharing mode is applied to all display areas of the display panel, so that the above-mentioned color difference can be avoided and the hue of the overall display panel will become uniform.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A power saving method applied to a plurality of source drivers of a display, a first source driver, a second source driver, . . . . and a K-th source driver of the plurality of source drivers corresponding to a first display area, a second display area, . . . and a K-th display area of a display panel respectively, the first source driver comprising a plurality of first output channels, the second source driver comprising a plurality of second output channels, . . . , and the K-th source driver comprising a plurality of K-th output channels, K being a positive integer larger than 1, the power saving method comprising steps of:
(a) dividing the plurality of first output channels of the first source driver into a plurality of sets of first output channels and each set of first output channels comprises M first output channels, wherein M is a positive integer;
(b) setting a charge-sharing average register;
(c) selecting whether the data signal is reverse processed;
(d) calculating an average of the (N−1)-th data line after charge-sharing, wherein N is a positive integer larger than 1;
(e) determining whether the data signal outputted by each output channel consumes power from the (N−1)-th data line to the N-th data line respectively;
(f) calculating a total power consumption of the data signal transmitted from the (N−1)-th data line to the N-th data line under all charge-sharing modes;
(g) selecting a first candidate lowest power consumption charge-sharing mode corresponding to the first source driver from all charge-sharing modes;
(h) repeatedly performing the step (a) to the step (g) on the second source driver to the K-th source driver respectively to select a second candidate lowest power consumption charge-sharing mode corresponding to the second source driver to a K-th candidate lowest power consumption charge-sharing mode corresponding to the K-th source driver respectively;
(i) voting a lowest power consumption charge-sharing mode from the first candidate lowest power consumption charge-sharing mode to the K-th candidate lowest power consumption charge-sharing mode; and
(j) controlling operations of the plurality of source drivers according to the lowest power consumption charge-sharing mode.

2. The power saving method of claim 1, wherein if each first output channel has J charge-sharing paths, then the M first output channels totally correspond to (J+1)^{M} charge-sharing average registers, wherein J is a positive integer.

3. The power saving method of claim 1, wherein the step (e) is to determine whether the power is consumed according to a voltage-level change of the data signal outputted by each first output channel when the data signal is transmitted from the (N−1)-th display line to the N-th display line.

4. The power saving method of claim 3, wherein if the voltage-level change is far away from a reference voltage-level, then the step (e) determines that the power is consumed.

5. The power saving method of claim 4, wherein the reference voltage-level is a ground voltage.

6. The power saving method of claim 3, wherein if the voltage-level change is approaching a reference voltage-level, then the step (e) determines that no power is consumed.

7. The power saving method of claim 6, wherein the reference voltage-level is a ground voltage.

8. The power saving method of claim 1, wherein if the step (c) selects a normally white mode, the data signal is reverse processed; if the step (c) selects a normally black mode, the data signal is not reverse processed.

9. The power saving method of claim 1, wherein the step (j) achieves the lowest power consumption charge-sharing mode for the K source drivers by switching the coupling relationship between the plurality of first output channels, switching the coupling relationship between the plurality of second output channels, . . . and switching the coupling relationship between the plurality of K-th output channels respectively.

10. The power saving method of claim 1, wherein the first candidate lowest power consumption charge-sharing mode to the K-th candidate lowest power consumption charge-sharing mode are the same or different from each other, and the step (i) is to select one of the first candidate lowest power consumption charge-sharing mode to the K-th candidate lowest power consumption charge-sharing mode having the highest number of votes as the lowest power charge sharing mode.
